(19) United States
(12) Patent Application Publication
(10) Pub. No.: US 2006/0120814 A1
(43) Pub. Date: Jun. 8, 2006

(54) Combination tool

(76) Inventors: Steve P. Lipohar, Bedford, OH (US); Terry R. Reitz, Latrobe, PA (US)

Correspondence Address: KENNAMETAL INC., P.O. BOX 231, 1600 TECHNOLOGY WAY, LATROBE, PA, 15650, US

(21) Appl. No.: 11/003,625

(22) Filed: Dec. 2, 2004

(51) Int. Cl. B23B 51/10

(52) U.S. Cl. 408/181

(57) ABSTRACT

A machining tool comprising a rotatable sleeve, a removable, axially adjustable leading element, such as a drill bit, mounted in the sleeve and a throw-away or regrindable cutting insert mounted in a fixed, unadjustable position on the sleeve to fix the position of the cutting edge on the insert axially in relation to the leading element and the sleeve. A shank of the drill bit is inserted through the sleeve to expose a portion of the shank of the drill bit. The exposed shank is then directly attached to a drill for rotating the machining tool, thereby reducing stack tolerances and runout during cutting operations. In addition, angled portions are included on both a peripheral side of the cutting insert and the holder to prevent the cutting insert from separating from the drill bit due to torque generated from cutting operations.

### BACKGROUND OF THE INVENTION

1. Field of the Invention

The present invention relates generally to machining tools, and more particularly to a combination tool that performs two or more machining functions, such as drilling and countersinking or to machining tools with removable pilots.

2. Description of the Related Art

Drilling tools are commonly used to drill a hole in an object for receiving a fastening element, such as a bolt, to secure another part to the object in which the hole was drilled. It is oftentimes desirable to countersink the top of the hole or to spot face the flat surface area around the top of the hole to effect a close mating relation between the object in which the hole is drilled and the mating part bolted to said object. It is also desirable to combine the drilling function in one continuous operation with the countersinking function or spot facing function or both. To accomplish this combined operation, a combined drilling and cutting tool is used. This tool comprises a drill bit mounted on a rotatable holder on which a cutting element of some type is mounted or permanently attached in predetermined relation to the drill bit. The cutting element may perform the countersinking or spot facing functions or both.

In conventional machining tools in which both drilling and cutting operations are combined, the holder includes a shank for attaching to a driving means for rotating the tool. The drill bit includes a shank which is completely received within the holder and fixed in position by a set screw. In one example of such a conventional machining tool, the shank of the drill bit is received in the holder, which in turn, is attached to the driving means for rotating the tool. Because the shank of the drill bit is not directly attached to the driving means, stack tolerances are increased in such a conventional machining tool.

There are some applications in which the cutting edge of the cutting element must be maintained a fixed, predetermined distance from the tip of the drill bit. This is to assure that the function performed by the cutting edge of the insert occurs on a surface spaced the correct distance from the bottom of the hole drilled by the drill bit. If the cutting edge were not maintained a fixed, predetermined distance from the tip of the drill bit, the object undergoing machining by the combined tool would be incorrectly machined.

In conventional machining tools, the cutting element is maintained in the fixed, predetermined distance from the tip of the drill bit by mounting the cutting element on a seating surface of the holder. Usually, the cutting element is mounted on the seating surface of the holder by a first, flat peripheral side engaging a first locating wall of the holder and a second, flat peripheral side engaging a second locating wall on the drill bit. Because both the first and second peripheral sides are flat, the cutting element tends to separate from and no longer securely engages the drill bit during cutting operations due to forces exerted on the cutting element.

The inventor of the present invention has discovered a machining tool that reduces stack tolerances and runout during cutting operations. In addition, the inventor has discovered a machining tool that securely mounts the cutting element to the seating surface of the holder to prevent separation of the cutting element from the drill bit during cutting operations.

### SUMMARY OF THE INVENTION

One aspect of the invention is to provide a machining tool that reduces stack tolerances and runout during cutting operations. The tool comprises a sleeve including a hole extending along preferably a central axis of the sleeve, a seating surface, and a first locating surface. A drill bit includes a second locating surface, a shank and a head portion terminating at a tip. A cutting insert includes a first peripheral side for engaging the first locating surface of the sleeve, and a second peripheral side for engaging the second locating surface of the drill bit. The drill bit is received within the hole of the sleeve to expose at least a portion of the shank of the drill bit. The exposed portion of the shank of the drill bit is attached directly to a driving means for rotating the tool, rather than the shank of the holder, thereby reducing stack tolerances and runout of the machining tool.

In another aspect of the invention, a machining tool comprises a sleeve including a hole extending along preferably a central axis of the sleeve, a seating surface, and a first locating surface. A drill bit includes a second locating surface, a shank and a head portion terminating at a tip. A cutting insert includes a first peripheral side and a second peripheral side for engaging the second locating surface of the drill bit. The first locating surface of the sleeve includes first and second angled portions. In addition, the first peripheral side of the insert includes first and second angled portions for engaging the first and second angled portions of the first locating surface of the sleeve. The angled portions of the cutting insert and the holder prevent the cutting insert from separating from the drill bit during cutting operations.

### BRIEF DESCRIPTION OF THE DRAWINGS

While various embodiments of the invention are illustrated, the particular embodiments shown should not be construed to limit the claims. It is anticipated that various changes and modifications may be made without departing from the scope of this invention.

In the drawings:

FIG. 1 is an exploded perspective of a combined drilling and cutting tool according to an embodiment of the invention.

FIG. 2 is an enlarged front sectional view of the combined drilling and cutting tool of FIG. 1.

FIG. 3 is a fragmentary side view of the embodiment of FIG. 1.

FIG. 4 is a sectional view taken along ling 4-4 of FIG. 2.

### DESCRIPTION OF THE PREFERRED EMBODIMENT

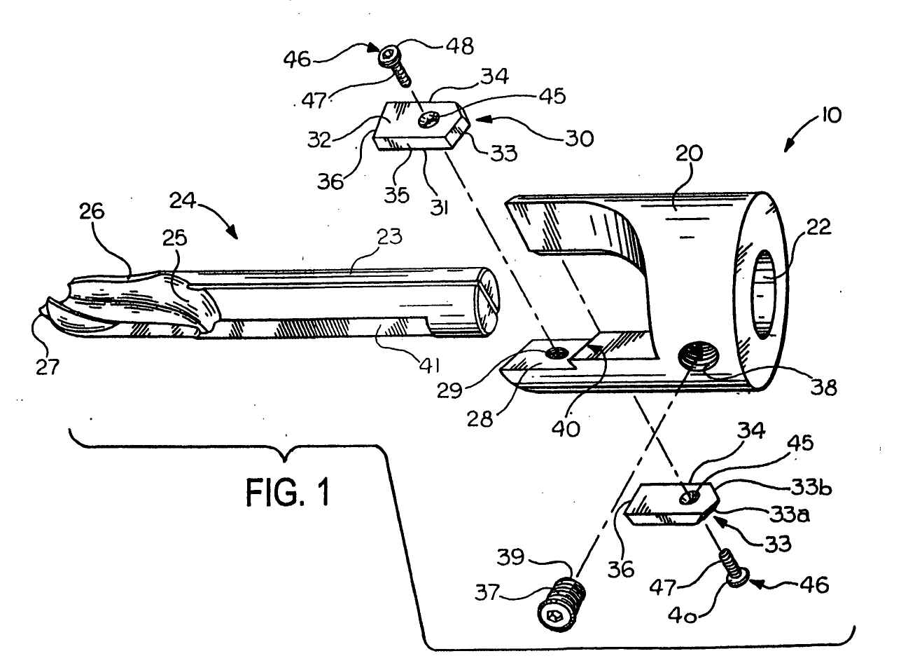

Referring initially to FIGS. 1-4, there is illustrated an embodiment of a combined drilling and cutting tool 10 according to an embodiment of the invention. The tool 10 includes a rotatable sleeve 20. Extending along preferably a central axis, B, of sleeve 20 is an elongated hole 22 for receiving the shank 23 of a removable leading element, in this embodiment a drill bit 24 having a head or drilling portion 25 including a helical recess 26 and terminating at a tip 27. For example, the removable leading element may also comprise a reamer, an end mill or a removable pilot.

The reception of shank 23 in hole 22 mounts drill bit 24 for rotation about its axis and for axial adjustment in relation to sleeve 20.

One aspect of the invention is that shank 23 extends upwardly from sleeve 20 for attachment to driving means for rotating the tool 10. This feature allows the tool 10 to clamp directly to shank 23 of drill bit 24, unlike conventional tools in which the shank (not shown) of sleeve 20 is clamped by the tool. As a result, the tool 10 of the invention provides for less stack tolerances and less runout than conventional tools.

Sleeve 20 comprises a seating surface 28 through which extends an opening 29. Mounted on seating surface 28 is a cutting insert 30 having inside and outside surfaces 31, 32 respectively and a plurality of peripheral sides 33-36.

Sleeve 20 includes a first locating surface 40, adjacent seating surface 28, for engaging peripheral side 33 of insert 30. First locating surface 40 includes first and second angled portions 40a, 40b for engaging first and second angled portions 33a, 33b of insert 30, respectively. Angled portions 33b, 40b are preferably formed at an angle, A, in the range of approximately 5 to 10 degrees, and preferably in the range of approximately 8 to 9 degrees, and most preferably approximately 8.5 degrees with respect to a horizontal axis, H, of drill bit 24. Conventional inserts that do not include angled portions 33a, 33b, 40a, 40b have a tendency to “lift” out of the seating surface 28 of sleeve 20 due to the radial torque generated by the cutting forces of the drill bit 24 and the insert 30 during cutting operations.

Another aspect of the invention is that angled portions 33a, 33b of insert 30 engage angled portions 40a, 40b of sleeve 20 to prevent second locating surface 41 and peripheral side 34 of insert 30 from separating from each other during cutting operations. Further, the angled portions 33a, 33b of insert 30 and angled portions 40a, 40b of sleeve 20 prevent the insert 30 from lifting out of the seating surface 28 during cutting operations.

Drill bit 24 comprises a flat second locating surface 41 for engaging flat peripheral side 34 of insert 30. Peripheral sides 33, 34 of insert 30 are angularly disposed to each other, and, when drill bit 24 is properly assembled on sleeve 20, locating surfaces 40, 41 are angularly disposed to each other in the same angular relation as are peripheral sides 33, 34 of the insert. In an alternative embodiment, the second locating surface 41 may comprise a whistle notch having a small angle, for example, about 2° with respect to the central axis, C, of the drill bit 24 to prevent axial movement of the drill bit 24 due to torque generated during cutting operations.

Removable drill bit 24 is held in place on sleeve 20, in predetermined, axial and rotative positions relative to sleeve 20, by a set screw 37 extending through a threaded opening 38 in sleeve 20. The tip 39 of set screw 37 engages against an extension of flat locating surface 41 on drill bit 24 to secure the removable drill bit to sleeve 20. In the alternative embodiment in which the second locating surface 41 comprises a whistle notch, the threaded opening 38 may be at small angle corresponding to the small angle of the second locating surface 41 of the drill bit 24, for example, about 2°, so that the set screw 37 will fully engage the second locating surface 41 of the drill bit 24.

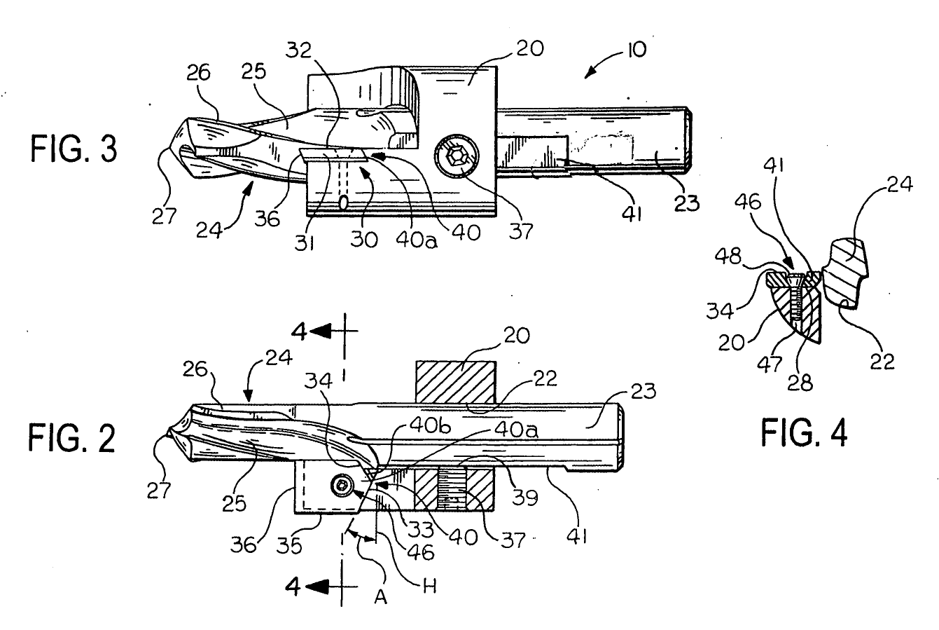

It will be appreciated that the drill bit 24 may include more than one flat locating surface 41. For example, a second flat locating surface (not shown) may be located approximately 180 degrees from flat locating surface 41. As shown in FIG. 2, locating surface 41 on drill bit 24 is remote from tip 27 of the drill bit and is recessed in relation to the periphery 50 of drilling portion 25. When the drill bit is in its predetermined rotative position, locating surface 41 is positioned to engage the insert's second peripheral side 34.

As is also shown in FIG. 2, the third peripheral side 36 is opposite the first peripheral side 33 that extends angularly to the insert's second peripheral side 34. The third peripheral side 36 forms a flat cutting edge portion. It will be appreciated that the invention is not limited by the shape of the cutting edge portion 36, and that the invention can be practiced with a wide variety of desired cutting edges, such as countersinking cutting edge portions, spot facing cutting edge portions, and the like.

Extending through insert 30, from its outside surface 32 to its inside surface 31 is a beveled opening 45, that normally overlies opening 29 on seating surface 28 of sleeve 20. Insert 30 is mounted on seating surface 28, with a cam pin 46 comprising a stem portion 47 received in opening 29 of sleeve 20 and a beveled portion 48 received in the beveled opening 45 of insert 30.

Openings 45 and 29, in combination with cam pin 46, comprises means for mounting insert 30 between a locking position, in which insert 30 is fixed against movement relative to sleeve 20 and drill bit 24, and an unlocking position in which cam pin 46 and insert 30 are removable from sleeve 20. As cam pin 46 is rotated from its unlocking to its locking position, the outside surface of the cam pin's beveled portion 48 engages the inside surface of beveled opening 45 to urge insert peripheral surfaces 33, 33a, 33b of insert 30 toward engagement with locating surfaces 40, 40a, 44b on sleeve 20 and to urge insert peripheral surface 34 toward engagement with locating surface 41 on drill bit 24. As previously noted, first and second angled portions 40a, 40b engage first and second angled portions 33a, 33b to prevent locating surface 41 and peripheral side 34 of insert 30 from separating from each other during cutting operations and to prevent the insert 30 from lifting off seating surface 28 during cutting operations. Cam pin 46 is rotated between its locking and unlocking positions by inserting a tool (not shown), such as an Torx screwdriver, and the like, inside an appropriate opening 49 in beveled portion 48 of cam pin 46, as shown in FIG. 2.

When insert 30 is mounted in a fixed position on sleeve 20, the cutting edge portion 36 on insert 32 extends in a radial direction beyond the periphery 35 of drilling portion 25 (FIG. 2).

Cam pin 46, openings 45 and 29 and first locating surface 40 comprise means for fixing the position of cutting edge portion 36 axially in relation to drilling tip 27 and for preventing adjustment in an axial direction of the fixed position of the cutting edge portion 36. The distance between cutting edge portion 36 and drill tip 27 is predetermined in accordance with the desired dimensions of the object to be machined by the tool 10.

The patents and publications referred to herein are hereby incorporated by reference.

While the invention has been specifically described in connection with certain specific embodiments thereof, it is to be understood that this is by way of illustration and not of limitation, and the scope of the appended claims should be construed as broadly as the prior art will permit.

1. A machining tool comprising:
a sleeve, said sleeve including a hole extending along an axis of said sleeve, a seating surface, and a first locating surface;
a drill bit including a second locating surface, a shank and a head portion terminating at a tip;
a cutting insert including a first peripheral side for engaging said first locating surface of said sleeve, and a second peripheral side for engaging said second locating surface of said drill bit,
wherein said drill bit is received within said hole of said sleeve to expose at least a portion of said shank and said head portion of said drill bit such that said shank of said drill bit and said head portion of said drill bit are exposed at opposite sides of said sleeve and said head portion is adjacent said cutting insert.

2. The tool according to claim 1, wherein said first locating surface of said sleeve includes one or more angled portions, and wherein said first peripheral side of said insert includes one or more angled portions for engaging said one or more angled portions of said first locating surface.

3. The tool according to claim 1, wherein said insert further includes an opening extending therethrough, and wherein said sleeve further includes an opening extending into said sleeve from said seating surface.

4. The tool according to claim 3, further including a cam pin extending through said opening in said insert and said opening in said seating surface for mounting said insert on said seating surface.

5. The tool according to claim 4, wherein said cam pin includes a beveled portion for engaging an inside surface of said opening in said insert to urge said first peripheral surface of said insert toward engagement with said first locating surface on said sleeve and to urge second peripheral surface of said insert toward engagement with said second locating surface on said drill bit.

6. The tool according to claim 1, wherein sad drill bit further includes one or more flat locating surfaces for fixing said drill bit in a predetermined axial position relative to said sleeve.

7. The tool according to claim 6, further includes a set screw extending through a threaded opening in said sleeve for fixing said drill bit in a predetermined rotative and axial position.

8. The tool according to claim 1, wherein said insert includes a third peripheral side forming a cutting edge, said cutting edge extending radially beyond the periphery of said head portion of said drill bit when said insert is mounted on said seating surface of said sleeve.

9. The tool according to claim 8, wherein said third peripheral side is opposite said first peripheral side and extends angularly with respect to said second peripheral side of said insert.

10. The tool according to claim 1, wherein said first and second peripheral sides of said insert are angularly disposed with respect to each other.

11. A machining tool comprising:
a sleeve, said sleeve including a hole extending along an axis of said sleeve, a seating surface, and a first locating surface;
a drill bit including a second locating surface, a shank and a head portion terminating at a tip;
a cutting insert having inside and outside surfaces, a first peripheral side and a second peripheral side for engaging said second locating surface of said drill bit,
wherein said first locating surface of said sleeve includes first and second angled portions, and wherein said first peripheral side of said insert includes first and second angled portions for engaging said first and second angled portions of said it locating surface of said sleeve, wherein said drill bit is received within said hole of said sleeve to expose at least a portion of said shank of said drill bit and to expose at least a portion of said head portion of said drill bit at opposite sides of said sleeve such that said head portion is adjacent said cutting insert.

12. The tool according to claim 11, wherein said first angled portion of said first locating surface of said sleeve and said first angled portion of said first peripheral side of said insert are formed at an angle of approximately 8 degrees with respect to a horizontal axis of said drill bit.

13. The tool according to claim 11, wherein said first and second locating surfaces of said sleeve are angularly disposed to each other in the same angular relation as said first and second peripheral sides of said insert.

14. The tool according to claim 11, wherein said cutting edge on the insert extending radially beyond the periphery of said head portion of said drill bit when said insert is mounted on said seating surface of said sleeve.

15. The tool according to claim 11, wherein said tool includes a cam pin having a beveled portion for engaging an inside surface of a beveled opening in said insert to urge said first peripheral surface of said insert toward engagement with said first locating surface on said sleeve and to urge second peripheral sure of said insert toward engagement with said second locating surface on said drill bit.

16. The tool according to claim 11, wherein said drill bit further includes one or more flat locating surfaces for fixing said drill bit in a predetermined axial position relative to said sleeve.

17. The tool according to claim 16, further includes a set screw extending through a threaded opening in said sleeve for fixing said drill bit in a predetermined rotative and axial position.

18. The tool according to claim 11, wherein said insert includes a third peripheral side forming a cutting edge, said cutting edge extending radially beyond the periphery of said head portion of said drill bit when said insert is mounted on said seating surface of said sleeve.

19. The tool according to claim 18, wherein said third peripheral side is opposite said first peripheral side that extends angularly with respect to said second peripheral side of said insert.

20. The tool according to claim 11, wherein said first and second peripheral sides of said insert are angularly disposed with respect to each other.
